(19) United States
(12) Patent Application Publication
(10) Pub. No.: US 2020/0039486 A1
(43) Pub. Date: Feb. 6, 2020

(54) ABS Retarder Disable for 6X2 vehicles

(71) Applicant: Bendix Commercial Vehicle Systems LLC, Elyria, OH (US)

(72) Inventors: Thomas S. Miller, JR., Lagrange, OH (US); Edward A. Fay, Peninsula, OH (US)

(21) Appl. No.: 16/051,995

(22) Filed: Aug. 1, 2018

(51) Int. Cl. B60T 8/171; B60T 17/18

(52) U.S. Cl. CPC B60T 8/171; B60T 17/18; B60T 2240/00; B60T 2220/04; B60T 2270/88

(57) ABSTRACT

An apparatus is provided for a vehicle having a driven rear axle and an undriven rear axle. The apparatus comprises a data storage device arranged to store a slip threshold at which a powertrain braking function is disabled, a first sensor for detecting speed of a wheel on the driven rear axle and providing a first signal indicative thereof, a second sensor for detecting speed of a wheel on the undriven rear axle and providing a second signal indicative thereof, a third sensor for detecting a condition of the vehicle and providing a third signal indicative thereof, and an electronic controller arranged to (i) process at least the first and second signals to provide a fourth signal indicative of an amount of slip, and (ii) modify the stored slip threshold value based on a combination of the third and fourth signals.

### BACKGROUND

The present application relates to vehicle braking systems, and is particularly directed to a method and apparatus for modifying a slip threshold value associated with powertrain braking of a vehicle, such as a heavy vehicle having an air braking system.

One type of heavy vehicle is a 6×2 tractor which has a front axle with two wheels and two rear axles with two wheels on each rear axle. The 6×2 tractor has a total of six wheels in which only the two wheels on one of the rear axles is driven, and hence is sometimes referred to as a “6×2 vehicle”. From time to time during operation of a 6×2 vehicle, the two wheels on the driven rear axle may experience rear axle slip (i.e., longitudinal wheel slip), which reduces lateral grip. When this occurs, the two wheels on the undriven rear axle provide grip to provide lateral stability. Disabling powertrain braking is sometimes used to improve grip and lateral stability when longitudinal wheel slip occurs.

Those skilled in the art continue with research and development efforts in the field of powertrain braking for heavy vehicles such as 6×2 vehicles.

### SUMMARY

In accordance with one embodiment, an apparatus is provided for a vehicle having at least one driven rear axle and at least one undriven rear axle. The apparatus comprises a data storage device arranged to store a slip threshold value at which a powertrain braking function of the vehicle is disabled. The apparatus further comprises a first sensor for detecting wheel speed of a wheel on the driven rear axle of the vehicle and providing a first signal indicative thereof, a second sensor for detecting wheel speed of a wheel on the undriven rear axle of the vehicle and providing a second signal indicative thereof, and a third sensor for detecting a condition of the vehicle and providing a third signal indicative thereof. The apparatus also comprises an electronic controller arranged to (i) process at least the first and second signals to provide a fourth signal indicative of an amount of longitudinal wheel slip between the driven rear axle and the undriven rear axle, and (ii) modify the stored slip threshold value based on a combination of the third and fourth signals.

In accordance with another embodiment, an apparatus is provided for a vehicle having at least one driven rear axle and at least one undriven rear axle. The apparatus comprises a data storage device arranged to store a slip threshold value at which a powertrain braking function of the vehicle is disabled. The apparatus further comprises a sensor for detecting intent of a vehicle driver applying brakes of the vehicle and providing a signal indicative thereof. The apparatus also comprises an electronic controller arranged to modify the stored slip threshold value when the signal from the sensor indicates that the vehicle driver is not applying the vehicle brakes.

In accordance with yet another embodiment, a method is provided of operating a vehicle having at least one driven rear axle and at least one undriven rear axle. The method comprises storing a slip threshold value at which a powertrain braking function of the vehicle is disabled. The method further comprises detecting wheel speed of a wheel on a driven rear axle of the vehicle and providing a first signal indicative thereof, detecting wheel speed of a wheel on an undriven rear axle of the vehicle and providing a second signal indicative thereof, and detecting a condition of the vehicle and providing a third signal indicative thereof. The method also comprises determining an amount of longitudinal wheel slip between the wheel on the driven rear axle and the wheel on the undriven rear axle based on a reference velocity and at least the first and second signals and providing a fourth signal indicative thereof. The method further comprises modifying the stored slip threshold value based on a combination of the third and fourth signals and providing a modified slip threshold value.

### BRIEF DESCRIPTION OF THE DRAWINGS

FIG. 1 is a schematic diagram of an example 6×2 vehicle constructed in accordance with an embodiment.

FIG. 2 is a schematic block diagram of an electronic control device used in the example 6×2 vehicle of FIG. 1.

FIG. 3 is a flow diagram depicting a method of operating the electronic control device of FIG. 2 in accordance with an embodiment.

FIG. 4 is an example sub-flow diagram depicting a portion of the flow diagram of FIG. 3.

FIG. 5 is a flow diagram depicting a method of operating the electronic control device of FIG. 2 in accordance with another embodiment.

FIG. 6 is a flow diagram depicting a method of operating the electronic control device of FIG. 2 in accordance with another embodiment.

FIG. 7 is a flow diagram depicting a method of operating the electronic control device of FIG. 2 in accordance with another embodiment.

FIG. 8 is a flow diagram depicting a method of operating the electronic control device of FIG. 2 in accordance with another embodiment.

### DETAILED DESCRIPTION

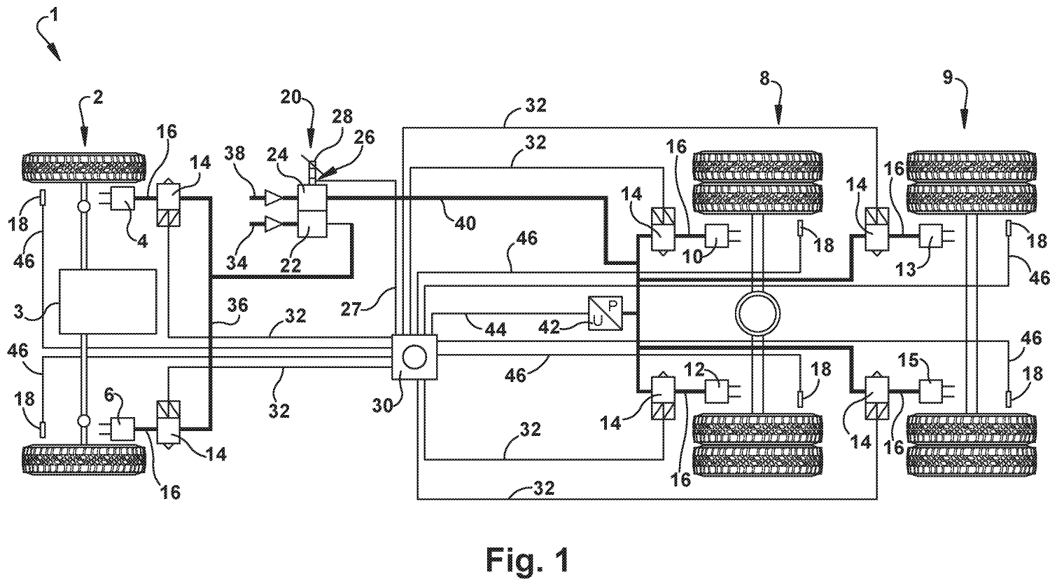

Referring to FIG. 1, a pneumatic brake device 1 in a vehicle, for example a 6×2 vehicle (i.e., a tandem), has two pneumatic brake cylinders 4, 6 on a vehicle front axle 2, two pneumatic brake cylinders 10, 12 on a driven rear axle 8, and two pneumatic brake cylinders 13, 15 on an undriven rear axle 9. The 6×2 vehicle has a motor 3 as a front-mounted engine which drives the wheels of the rear axle 8 via a shaft (not shown here).

The motor 3 may comprise any type of motor suitable for use in a vehicle. For example, the motor 3 may comprise a diesel motor. As another example, the motor 3 may comprise an electric motor. Other types of motors are possible. The motor 3 can be mounted anywhere on the vehicle. For example, the motor 3 can be a rear-mounted engine. Other mounting locations of the motor 3 are possible. Moreover, the driven axle may be any axle, including the front axle, of the vehicle.

The brake cylinders 4, 6, 10, 12, 13, 15 are each assigned a pressure control valve arrangement 14 which serves to modulate the brake pressure. In the example 6×2 vehicle, the pressure control valve arrangement 14 is embodied as an antilock brake system (ABS) pressure control valve for reducing, maintaining, and increasing the pressure. The latter are each connected to the respective brake cylinder 4, 6, 10, 12, 13, 15 by a brake line 16. Alternatively, the brake device 1 could also be an electro-pneumatic brake device or an electronic brake system (EBS) with pressure control modules as the pressure control arrangement.

A wheel speed sensor 18 for monitoring the wheel rotational behavior is connected to each of the wheels of the three vehicle axles 2, 8, 9. The brake device 1 is designed for brake slip-dependent and/or drive slip-dependent brake pressure modulation. The brake device 1 is also equipped with a brake value transmitter 20 which has two pneumatic channels 22, 24. An electric potentiometer 26 is provided for generating an electrical signal on electrical line 27 which is dependent on activation of a foot brake pedal 28 of the brake value transmitter 26 or on the braking request of the vehicle driver.

An electronic control device 30 of the brake device 1 is connected via a line network 32 to pressure control valve arrangements 14 of the three axles 2, 8, 9. The two pneumatic channels 22, 24 of the brake value transmitter 20 are, in terms of their design, commercially available dual-circuit service brake valves. The pneumatic front axle channel 22 of the brake value transmitter 20 is connected on the energy inflow side to a supply line 34 which is connected to a compressed air supply (not shown), and on the energy outflow side to the pressure control valves 14 of the front axle 2 by a control line 36. The pneumatic rear axle channel 24 is connected to a compressed air supply (not shown) by a supply line 38, and to the pressure control valves 14 of the driven rear axle 8 and the undriven rear axle 9 by a control line 40. Therefore, a front axle channel and a rear axle channel of the pneumatic brake device 1 of the vehicle can be controlled with the pneumatic channels 22, 24 of the brake value transmitter 20.

In addition, a pressure sensor 42 can be installed in the control line 40 of the rear axle channel 24. The pressure sensor 42 may comprise any conventional type pressure sensor. As an example, the pressure sensor 42 may comprise an electronic stability control (ESC) brake demand pressure sensor. The pressure sensor 42 transmits a pressure signal to the electronic control device 30 via an electrical signal line 44. The pressure signal also represents the braking request of the vehicle driver. However, the pressure sensor 42 is not additionally necessary to detect the braking request of the vehicle driver. Instead, the intent of the vehicle driver to brake can be detected by the electric potentiometer 26 or by the pressure sensor 42 or by another sensor. For example, a signal which represents the braking request of the vehicle driver and which is conducted on a controller area network (CAN) of the vehicle is also conceivable. However, it is also possible to detect the braking request of the vehicle driver redundantly, as described in the example embodiment, by signals of the electric potentiometer 26 or of the pressure sensor 42.

The electronic control device 30 receives signals indicating the wheel speeds of the wheels of the front axle 2, signals indicating the wheel speeds of the wheels of the driven rear axle 8, and signals indicating the wheel speeds of the wheels of the undriven rear axle 9. Each signal is received from a corresponding wheel sensor of the wheel speed sensors 18 which are connected to the electronic control device 30 via a line network 46.

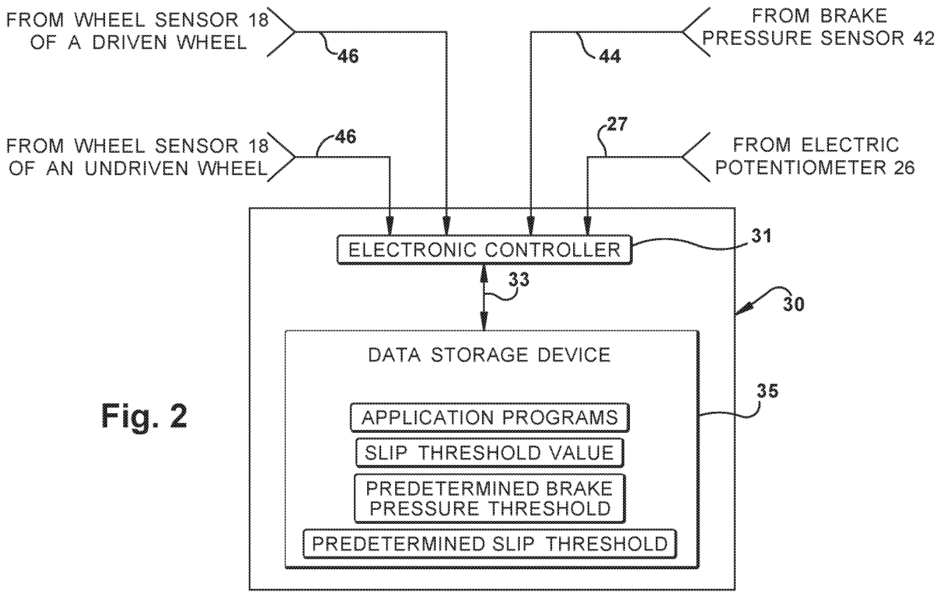

Referring to FIG. 2, a schematic block diagram of the electronic control device 30 used in the example 6×2 vehicle of FIG. 1 is illustrated. For simplicity and clarity of explanation, the signals from only two of the wheel sensors 18 on the line network 46 are shown in FIG. 2. Also, none of the signals from the electronic control device 30 to the pressure control valves 14 on the line network 32 are shown in FIG. 2.

Electronic control device 30 includes an electronic controller 31 that communicates on line 33 with a data storage device 35. Electronic controller 31 may comprise any type of computer, for example. The data storage device 35 stores, inter alia, one or more application programs, one or more differential slip threshold values, one or more predetermined brake pressure threshold values, and one or more predetermined slip threshold values. As examples for a typical vehicle application, a stored differential slip threshold value is in the range of 5% and 10%, a stored predetermined brake pressure threshold value is in the range of 5 pounds per square inch (psi) and 10 psi, and a stored predetermined slip threshold value is in the range of 5% and 20%. Structure and operation of various electronic controllers and various data storage devices are known and, therefore, will not be described.

In accordance with one or more features of the above-described example embodiment, the electronic control device 30 monitors output signals from a number of vehicle sensors, and disables a powertrain braking function of the vehicle when one or more output signals from one or more of the vehicle sensors meet certain criteria. In particular, the electronic control device 30 disables the powertrain braking function by modifying a stored longitudinal slip threshold (i.e., increasing the stored longitudinal slip threshold) when the one or more output signals meet the certain criteria. The modification of the slip threshold value that is stored in the data storage device 35 is provided in accordance with different methods to be described hereinbelow. More specifically, the electronic controller 31 provides a modified slip threshold value when the electronic controller 31 executes an application program stored in the data storage device 35.

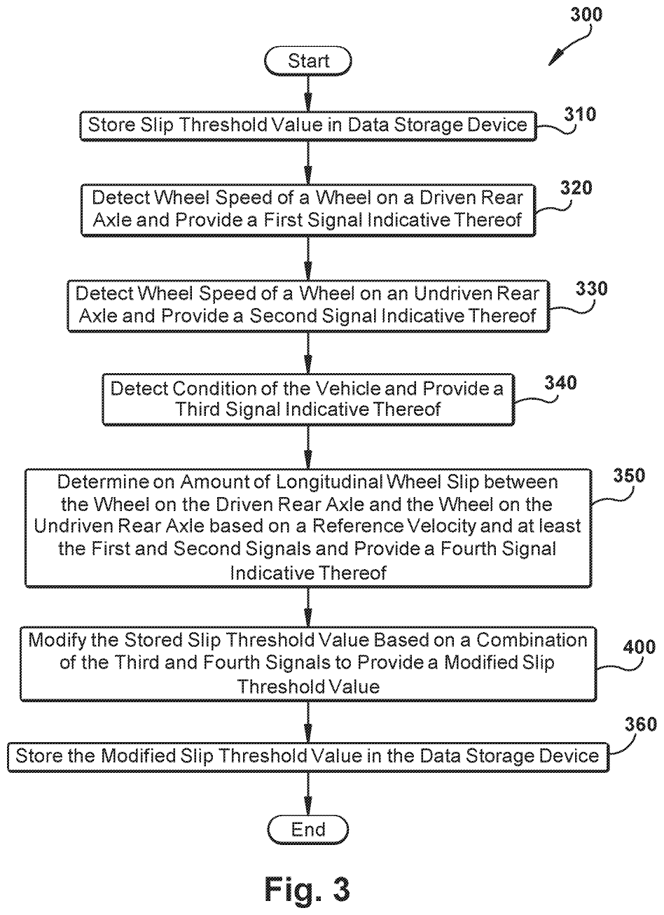

Referring to FIG. 3, a flow diagram 300 depicting a method of operating the electronic control device of FIG. 2 in accordance with an embodiment is illustrated. Application program instructions for enabling the electronic controller 31 shown in FIG. 2 to perform operation steps in accordance with flow diagram 300 shown in FIG. 3 may be embedded in memory internal to the electronic controller 31 (such as shown in FIG. 2). Alternatively, or in addition to, program instructions may be stored in memory external to the electronic controller 31. As an example, program instructions may be stored in memory internal to a different controller of the vehicle. Program instructions may be stored on any type of program storage media including, but not limited to, external hard drives, flash drives, and compact discs. Program instructions may be reprogrammed depending upon features of the particular electronic controller.

In block 310, a differential slip threshold value is stored in the data storage device 35. In block 320, the wheel speed of a wheel on a driven rear axle of the vehicle is detected, and a first signal is provided indicative thereof. Similarly in block 330, the wheel speed of a wheel on an undriven rear axle of the vehicle is detected, and a second signal is provided indicative thereof.

In block 340, a condition of the vehicle is detected, and a third signal is provided indicative thereof. As an example, the vehicle condition detected may comprise any combination of the signal on line 27 from the electric potentiometer 26 and the signal on line 44 from the pressure sensor 42, as best shown in FIG. 2. Then in block 350, an amount of longitudinal wheel slip between the wheel on the driven rear axle and the wheel on the undriven rear axle is determined. The determination is based on a reference velocity, the first signal from block 320, and the second signal from block 330, and a fourth signal is provided indicative thereof. In particular, the reference velocity takes into account any combination of wheel ends. The amount of longitudinal wheel slip is determined from the reference velocity to each of the respective wheels.

Then in block 400, a differential slip threshold value that is stored in the data storage device 35 is modified. Typically, the stored slip threshold value is modified to be greater than the stored slip threshold value that is unmodified by about 15 percentage value. The stored slip threshold value is modified based on a combination of the third signal from block 340 and the fourth signal from block 350. In block 360, the modified slip threshold value from block 400 is stored in the data storage device 35. The modified slip threshold value may be stored at the same location of the unmodified slip threshold value (i.e., the old slip threshold value) to replace the old slip threshold value, or may be stored at a different location in the data storage device 35. The process then ends.

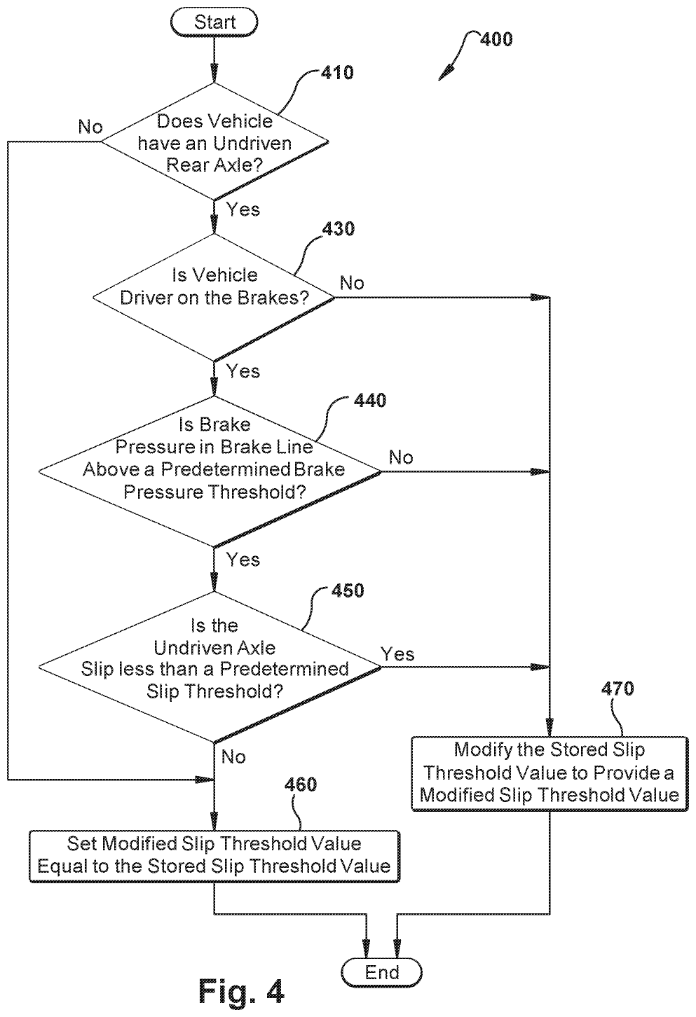

Referring to FIG. 4, an example sub-flow diagram 400 depicting a portion of the flow diagram 300 shown of FIG. 3 is illustrated. In particular, the sub-flow diagram of FIG. 4 shows additional details of block 400 in FIG. 3. In block 410, a determination is made as to whether the vehicle has an undriven rear axle. If the determination in block 410 is negative (i.e., the vehicle does not have an undriven rear axle), the process proceeds to block 460 in which a modified slip threshold value is set equal to the stored slip threshold value. However, if the determination in block 410 is affirmative (i.e., the vehicle does have an undriven rear axle), then the process proceeds to block 430 in which a determination is made as to whether the vehicle driver is on the brakes. This can be detected by monitoring the signal on the line 27 from the electric potentiometer 26 or the signal on the line 44 from the pressure sensor 42, or both.

If the determination in block 430 is negative (i.e., the vehicle driver is not on the brakes), then the process proceeds to block 470. In block 470, the slip threshold value that is stored in the data storage device 35 is modified to provide a modified slip threshold value. In the case when the vehicle driver is not on the brakes, there is little chance that the undriven rear axle 9 would be in slip. The process then proceeds to block 360 in FIG. 3. However, if the determination in block 430 is affirmative (i.e., the vehicle driver is on the brakes), then the process proceeds to block 440.

In block 440, a determination is made as to whether the brake pressure in a brake line is above a predetermined brake pressure that is stored in the data storage device 35. If the determination in block 440 is negative (i.e., the brake pressure is not above the predetermined brake pressure), the process proceeds to block 470. In block 470, the slip threshold value that is stored in the data storage device 35 is modified to provide a modified slip threshold value. In the case when the brake pressure is not above the predetermined brake pressure, this indicates that the vehicle driver is being either light on the brakes or not on the brakes at all. The process then proceeds to block 360 in FIG. 3. However, if the determination in block 440 is affirmative (i.e., the brake pressure is above the predetermined brake pressure), the process proceeds to block 450.

In block 450, a determination is made as to whether the slip of the undriven axle is less than a predetermined slip threshold that is stored in the data storage device 35. If the determination in block 450 is affirmative (i.e., the slip of the undriven axle is less than the predetermined slip threshold), the process proceeds to block 470. In block 470, the slip threshold value that is stored in the data storage device 35 is modified to provide a modified slip threshold value. The process then proceeds to block 360 in FIG. 3. However, if the determination in block 450 is negative (i.e., the slip of the undriven axle is not less than the predetermined slip threshold), the process proceeds to block 460. In block 460, a modified slip threshold value is created by setting it equal to the slip threshold value that is presently stored in the data storage device 35. The process then proceeds to block 360 in FIG. 3.

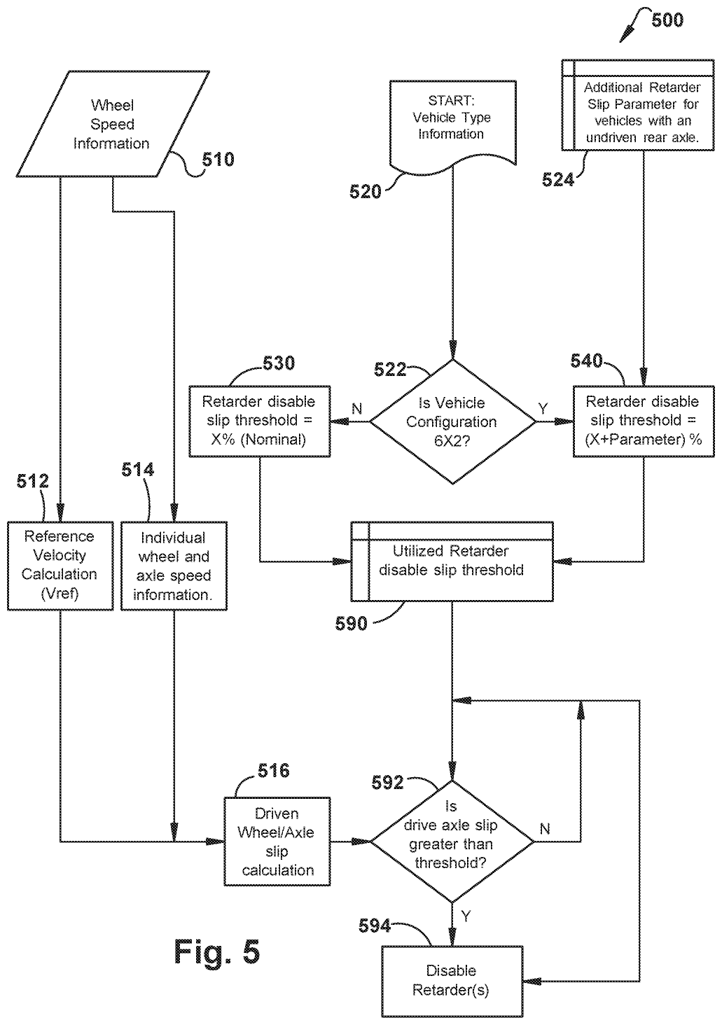

Referring to FIG. 5, a flow diagram 500 depicting a method of operating the electronic control device of FIG. 2 in accordance with another embodiment is illustrated. In block 510, wheel speed information from the wheel sensors 18 is obtained. Based upon the wheel speed information from block 510, a reference velocity (designated as “V_{ref}”) is calculated as shown in block 512. As an example, the reference velocity V_{ref} is a function of signals from any combination of the wheel sensors 18. Also, based upon the wheel speed information from block 510, axle speed as well as individual wheel speed are derived as shown in block 514. Then, as shown in block 516, a driven wheel slip or an axle slip, or both, are calculated based upon the reference velocity V_{ref} from block 512 and the wheel/axle slip information from block 514.

Vehicle type information about the particular vehicle as shown in block 520 is used to determine if the vehicle is configured as a 6×2 vehicle as shown in block 522. If the determination in block 522 is negative (i.e., the vehicle is not a 6×2 vehicle), then the process proceeds to block 530. In block 530, a retarder disable slip threshold is set to be equal to a nominal percentage value (designated as “X” percent in FIG. 5) of a stored slip threshold value. The stored slip threshold value is stored in a data storage device such as the data storage device 35 shown in FIG. 2. Other data storage locations are possible. The nominal percentage value is in the range of 5% to 20% depending upon the particular application. For example, the nominal percentage value may be 12.5%.

However, if the determination in block 522 is affirmative (i.e., the vehicle is a 6×2 vehicle), then the process proceeds to block 540. In block 540, an additional slip parameter value (shown as being from block 524 in FIG. 5) is added to the nominal percentage value (i.e., the “X” value) discussed hereinabove with respect to block 530. As such, the retarder disable slip threshold is set equal to the nominal percentage value plus the additional slip parameter value. The additional slip parameter value is typically up to a value of “15%”. Accordingly, the retarder disable slip threshold can be as high as 35% in the example implementation described herein. Depending upon the determination made in block 522, either the retarder disable slip threshold from block 530 or the retarder disable slip threshold from block 540 is used as shown in block 590.

A determination is then made in block 592 as to whether the driven axle slip (or the driven wheel slip) as calculated in block 516 is greater than the retarder disable slip threshold of block 590. If the determination in block 592 is affirmative (i.e., the driven axle slip is greater than the retarder disable slip threshold), then the process proceeds to block 594. In block 594, the retarder function of the vehicle is disabled. When the retarder function is disabled, a control system of the vehicle, such as an ABS system, is activated to reduce the driven axle slip so as to maximize vehicle control. By reducing the longitudinal wheel slip on the driven axle, stability of the rear of the vehicle is improved. However, if the determination in block 592 is negative (i.e., the driven axle slip is not greater than the retarder disable slip threshold), then the process returns on itself in block 592 to continue monitoring the driven axle slip.

It should be apparent from the above-described embodiment that the powertrain braking function of the vehicle is disabled (i.e., the negative torque from braking is retarded) when the signals from a number of vehicle sensors meet certain criteria.

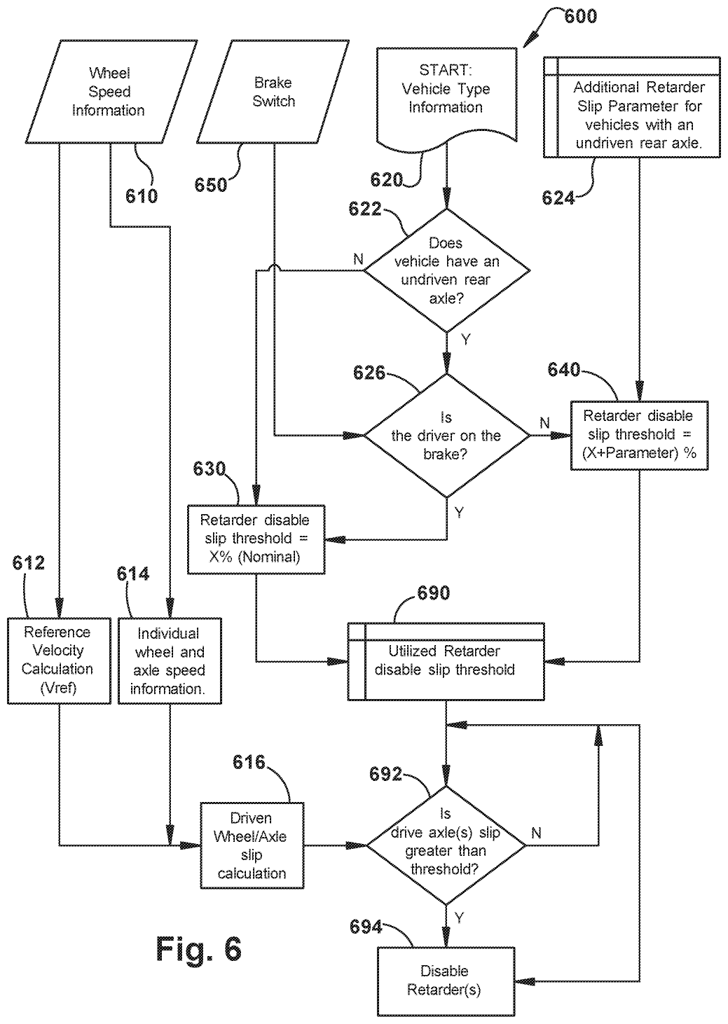

Referring to FIG. 6, a flow diagram 600 depicting a method of operating the electronic control device of FIG. 2 in accordance with another embodiment is illustrated. In block 610, wheel speed information from the wheel sensors 18 is obtained. Based upon the wheel speed information from block 610, a reference velocity (designated as “V_{ref}”) is calculated as shown in block 612. Also, based upon the wheel speed information from block 610, axle speed as well as individual wheel speed are derived as shown in block 614. Then, as shown in block 616, a driven wheel slip or an axle slip, or both, are calculated based upon the reference velocity V_{ref} from block 612 and the wheel/axle slip information from block 614.

Vehicle type information about the particular vehicle as shown in block 620 is used to determine if the vehicle has an undriven rear axle as shown in block 622. If the determination in block 622 is negative (i.e., the vehicle does not have an undriven rear axle), then the process proceeds to block 630. In block 630, a retarder disable slip threshold is set to be equal to a nominal percentage value (designated as “X” percent in FIG. 6) of a stored slip threshold value. The stored slip threshold value is stored in a data storage device such as the data storage device 35 shown in FIG. 2. Other data storage locations are possible. The nominal percentage value is in the range of 5% to 20% depending upon the particular application. For example, the nominal percentage value may be 12.5%.

However, if the determination in block 622 is affirmative (i.e., the vehicle has an undriven rear axle), then the process proceeds to block 626. In block 626, based upon a signal from the brake switch (i.e., the electric potentiometer 26 shown in FIG. 1 and block 650 shown in FIG. 6), a determination is made as to whether the vehicle driver is on brake. If the determination in block 626 is affirmative (i.e., the vehicle driver is on the brake), the process proceeds to block 630 in which the retarder disable slip threshold is set to be equal to the nominal percentage value of a stored slip threshold value as described hereinabove. However, if the determination in block 626 is negative (i.e., the vehicle driver is not on the brake), the process proceeds to block 640.

In block 640, an additional slip parameter value (shown as being from block 624 in FIG. 6) is added to the nominal percentage value (i.e., the “X” value) discussed hereinabove with respect to block 630. As such, the retarder disable slip threshold is set equal to the nominal percentage value plus the additional slip parameter value. The additional slip parameter value is typically up to a value of “15%”. Accordingly, the retarder disable slip threshold can be as high as 35% in the example implementation described herein. Depending upon the determinations made in blocks 622 and 626, either the retarder disable slip threshold from block 630 or the retarder disable slip threshold from block 640 is used as shown in block 690.

A determination is then made in block 692 as to whether the driven axle slip (or the driven wheel slip) as calculated in block 616 is greater than the retarder disable slip threshold of block 690. If the determination in block 692 is affirmative (i.e., the driven axle slip is greater than the retarder disable slip threshold), then the process proceeds to block 694. In block 694, the retarder function of the vehicle is disabled. When the retarder function is disabled, a control system of the vehicle, such as an ABS system, is activated to reduce the driven axle slip so as to maximize vehicle control. By reducing the longitudinal wheel slip on the driven axle, stability of the rear of the vehicle is improved. However, if the determination in block 692 is negative (i.e., the driven axle slip is not greater than the retarder disable slip threshold), then the process returns on itself in block 692 to continue monitoring the driven axle slip.

It should be apparent that the retarder disable slip threshold is increased when the driver is not on the brakes. As such, it becomes more difficult to disable the powertrain braking function when the vehicle driver is not on the brakes. It is desirable to disable the powertrain braking function when the driver is not on the brakes because the undriven axle should not have any appreciable slip and, therefore, the lateral stability of the vehicle should be high. Lateral stability should be high since the undriven rear axle with no appreciable slip provides maximum lateral grip. Accordingly, it is desirable in this case to allow more driven axle slip.

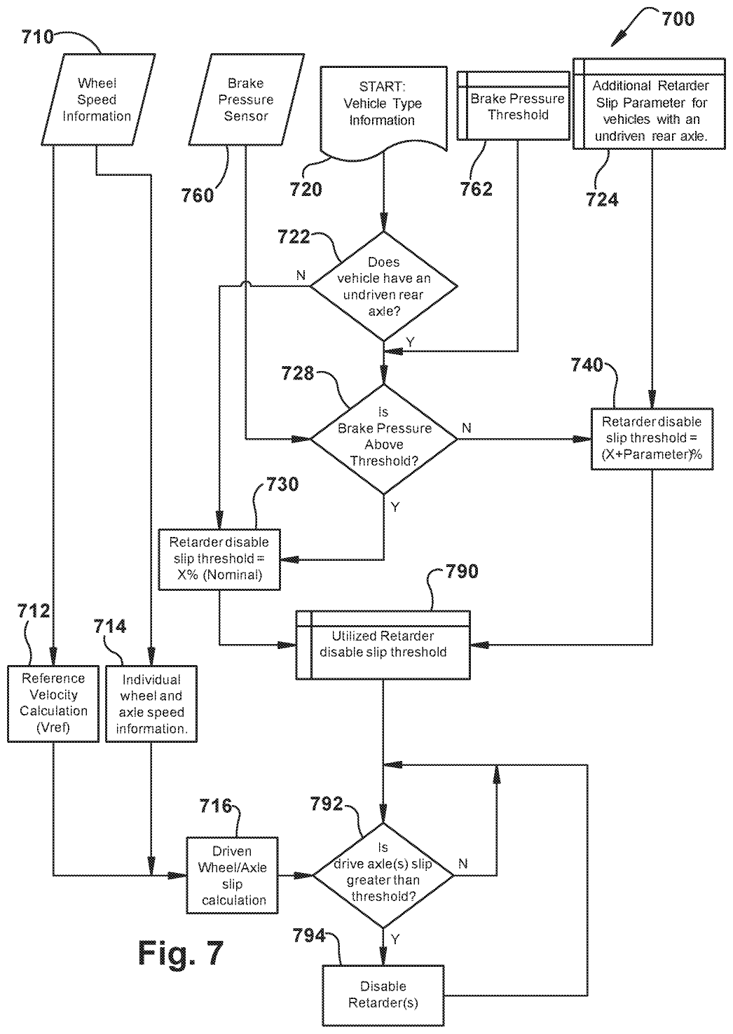

Referring to FIG. 7, a flow diagram 700 depicting a method of operating the electronic control device of FIG. 2 in accordance with another embodiment is illustrated. In block 710, wheel speed information from the wheel sensors 18 is obtained. Based upon the wheel speed information from block 710, a reference velocity (designated as “V_{ref}”) is calculated as shown in block 712. Also, based upon the wheel speed information from block 710, axle speed as well as individual wheel speed are derived as shown in block 714. Then, as shown in block 716, a driven wheel slip or an axle slip, or both, are calculated based upon the reference velocity V_{ref} from block 712 and the wheel/axle slip information from block 714.

Vehicle type information about the particular vehicle as shown in block 720 is used to determine if the vehicle has an undriven rear axle as shown in block 722. If the determination in block 722 is negative (i.e., the vehicle does not have an undriven rear axle), then the process proceeds to block 730. In block 730, a retarder disable slip threshold is set to be equal to a nominal percentage value (designated as “X” percent in FIG. 7) of a stored slip threshold value. The stored slip threshold value is stored in a data storage device such as the data storage device 35 shown in FIG. 2. Other data storage locations are possible. The nominal percentage value is in the range of 5% to 20% depending upon the particular application. For example, the nominal percentage value may be 12.5%.

However, if the determination in block 722 is affirmative (i.e., the vehicle has an undriven rear axle), then the process proceeds to block 728. In block 728, based upon a signal from the brake pressure sensor (i.e., the pressure sensor 42 shown in FIG. 1 and block 760 shown in FIG. 7), a determination is made as to whether the brake pressure is above a predetermined brake pressure threshold as shown in block 762. If the determination in block 728 is affirmative (i.e., the brake pressure is above the predetermined brake pressure threshold), the process proceeds to block 730 in which the retarder disable slip threshold is set to be equal to the nominal percentage value of a stored slip threshold value as described hereinabove. However, if the determination in block is negative (i.e., the brake pressure is not above the predetermined brake pressure threshold), the process proceeds to block 740.

In block 740, an additional slip parameter value (shown as being from block 724 in FIG. 7) is added to the nominal percentage value (i.e., the “X” value) discussed hereinabove with respect to block 730. As such, the retarder disable slip threshold is set equal to the nominal percentage value plus the additional slip parameter value. The additional slip parameter value is typically up to a value of “15%”. Accordingly, the retarder disable slip threshold can be as high as 35% in the example implementation described herein. Depending upon the determinations made in blocks 722 and 728, either the retarder disable slip threshold from block 730 or the retarder disable slip threshold from block 740 is used as shown in block 790.

A determination is then made in block 792 as to whether the driven axle slip (or the driven wheel slip) as calculated in block 716 is greater than the retarder disable slip threshold of block 790. If the determination in block 792 is affirmative (i.e., the driven axle slip is greater than the retarder disable slip threshold), then the process proceeds to block 794. In block 794, the retarder function of the vehicle is disabled. When the retarder function is disabled, a control system of the vehicle, such as an ABS system, is activated to reduce the driven axle slip so as to maximize vehicle control. By reducing the longitudinal wheel slip on the driven axle, stability of the rear of the vehicle is improved. However, if the determination in block 792 is negative (i.e., the driven axle slip is not greater than the retarder disable slip threshold), then the process returns on itself in block 792 to continue monitoring the driven axle slip.

It should be apparent that the retarder disable slip threshold is increased when the driver is lightly on the brakes. As such, it becomes more difficult to disable the powertrain braking function when the vehicle driver is lightly on the brakes (i.e., when the brake pressure is not above the predetermined brake pressure threshold as determined in block 728). It is desirable to disable the powertrain braking function when the driver is lightly on the brakes because the undriven rear axle slip should not have any appreciable slip and should have maximum lateral stability. Accordingly, it is desirable in this case to allow more driven axle slip before disabling the retarder.

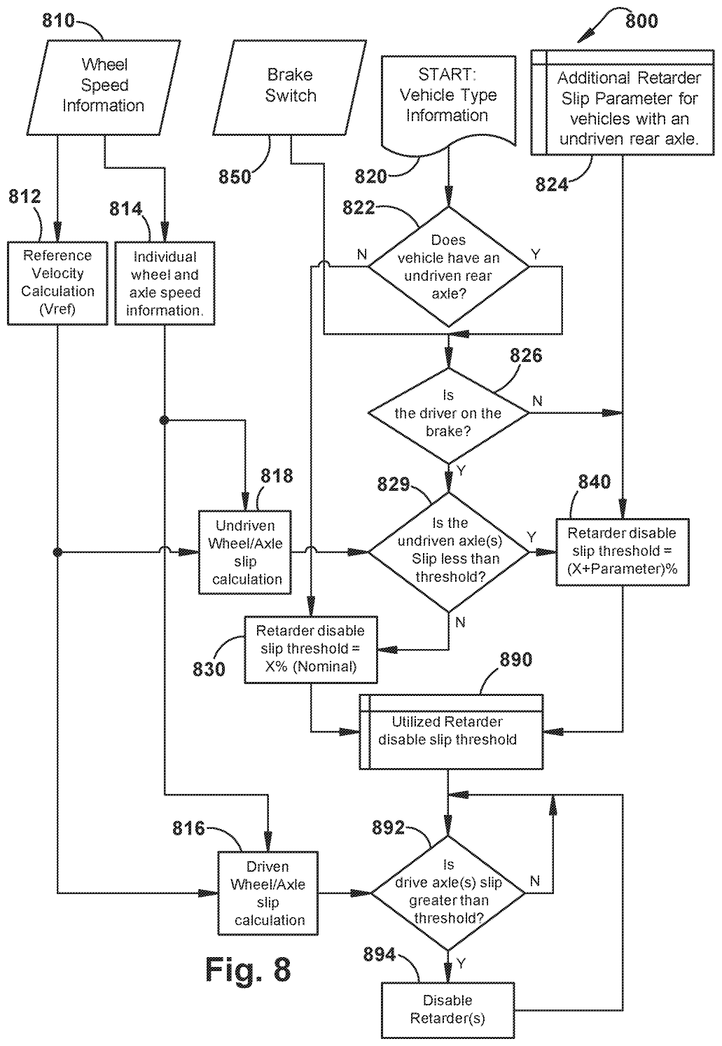

Referring to FIG. 8, a flow diagram 800 depicting a method of operating the electronic control device of FIG. 2 in accordance with another embodiment is illustrated. In block 810, wheel speed information from the wheel sensors 18 is obtained. Based upon the wheel speed information from block 810, a reference velocity (designated as “V_{ref}”) is calculated as shown in block 812. Also, based upon the wheel speed information from block 810, axle speed as well as individual wheel speed are derived as shown in block 814. Then, as shown in block 816, a driven wheel slip or an axle slip, or both, are calculated based upon the reference velocity V_{ref} from block 812 and the wheel/axle slip information from block 814. Moreover, as shown in block 818, an undriven wheel slip or an undriven axle slip, or both, are calculated based upon the reference velocity V_{ref} from block 812 and the wheel/axle slip information from block 814.

Vehicle type information about the particular vehicle as shown in block 820 is used to determine if the vehicle has an undriven rear axle as shown in block 822. If the determination in block 822 is negative (i.e., the vehicle does not have an undriven rear axle), then the process proceeds to block 830. In block 830, a retarder disable slip threshold is set to be equal to a nominal percentage value (designated as “X” percent in FIG. 8) of a stored slip threshold value. The stored slip threshold value is stored in a data storage device such as the data storage device 35 shown in FIG. 2. Other data storage locations are possible. The nominal percentage value is in the range of 5% to 20% depending upon the particular application. For example, the nominal percentage value may be 12.5%.

However, if the determination in block 822 is affirmative (i.e., the vehicle has an undriven rear axle), then the process proceeds to block 826. In block 826, based upon a signal from the brake switch (i.e., the electric potentiometer 26 shown in FIG. 1 and block 850 shown in FIG. 8), a determination is made as to whether the vehicle driver is on the brake. If the determination in block 826 is negative (i.e., the vehicle driver is not on the brake), the process proceeds to block 840. However, if the determination in block 826 is affirmative (i.e., the vehicle driver is on the brake), the process proceeds to block 829.

In block 829, a determination is made as to whether the slip of the undriven axle (or undriven wheel) from block 818 is less than a predetermined slip threshold. If the determination is block 829 is negative (i.e., the slip of the undriven axle is not less than the predetermined slip threshold), the process proceeds to block 830. In block 830, the retarder disable slip threshold is set to be equal to the nominal percentage value of a stored slip threshold value as described hereinabove. However, if the determination is block 829 is affirmative (i.e., the slip of the undriven axle is less than the predetermined slip threshold), the process proceeds to block 840.

In block 840, an additional slip parameter value (shown as being from block 824 in FIG. 8) is added to the nominal percentage value (i.e., the “X” value) discussed hereinabove with respect to block 830. As such, the retarder disable slip threshold is set equal to the nominal percentage value plus the additional slip parameter value. The additional slip parameter value is typically up to a value of “15%”. Accordingly, the retarder disable slip threshold can be as high as 35% in the example implementation described herein. Depending upon the determinations made in blocks 826 and 829, either the retarder disable slip threshold from block 830 or the retarder disable slip threshold from block 840 is used as shown in block 890.

A determination is then made in block 892 as to whether the driven axle slip (or the driven wheel slip) a calculated in block 816 is greater than the retarder disable slip threshold of block 890. If the determination in block 892 is affirmative (i.e., the driven axle slip is greater than the retarder disable slip threshold), then the process proceeds to block 894. In block 894, the retarder function of the vehicle is disabled. When the retarder function is disabled, a control system of the vehicle, such as an ABS system, is activated to reduce the driven axle slip so as to maximize vehicle control. By reducing the longitudinal wheel slip on the driven axle, stability of the rear of the vehicle is improved. However, if the determination in block 892 is negative (i.e., the driven axle slip is not greater than the retarder disable slip threshold), then the process returns on itself in block 892 to continue monitoring the driven axle slip.

It should be apparent that the retarder disable slip threshold is increased when the vehicle driver is on the brakes and the amount of longitudinal wheel slip on the undriven axle is less than a stored slip threshold value. As such, it is more difficult to disable the powertrain braking function when the vehicle driver is on the brakes and the amount of longitudinal wheel slip on the undriven axle is less than a stored slip threshold value. It is desirable to disable the powertrain braking function when the vehicle driver is on the brakes and the amount of longitudinal wheel slip on the undriven axle is less than a stored slip threshold value because the wheels of the undriven axle should have near maximum lateral grip. Accordingly, the driven axle can sustain higher slip before disabling the retarder.

Although the above description describes slip values defined in terms of positive percentages, it is conceivable that slip values be defined in other terms. For example, slip values may be defined in terms of negative percentages. As another example, slip values may be defined in terms of absolute values. If slip values are defined in terms other than positive percentages, then the arithmetic signs of slip values and their comparisons with slip values may be different from those described hereinabove for slip value percentages.

Although the above description describes use of one electronic controller, it is conceivable that any number of electronic controllers may be used. As an example, the implementation of the disabling of the powertrain braking function of the vehicle may have its own dedicated electronic controller. Moreover, it is conceivable that any type of electronic controller may be used. Suitable electronic controllers for use in vehicles are known and, therefore, have not been described.

Also, although the above description describes each of the methods of FIGS. 3-8 as comprising a number of different criteria, it is conceivable that each of the methods may comprise any combination of the different criteria. It is also conceivable that each of the methods may include a combination of other criteria not shown in FIGS. 3-8.

Further, although the above description describes the electronic control device 30 being used in a 6×2 vehicle to disable the powertrain braking function, it is conceivable that the electronic control device 30 may be used in other types of vehicles, such as an 8×2 vehicle (i.e., a tridem) which has three rear axles with only one of the rear axles being driven and the other two axles being undriven, or an 8×4 vehicle which has three axles with two of the rear axles being driven and the other axle being undriven. It is also conceivable that the electronic control device 30 may be used in other types of “vehicles” such as busses, recreational vehicles, railway cars, bulldozers, fork lifts, and the like where at least one of a plurality of rear axles is driven and at least one of the plurality of rear axles is undriven.

Also, although the above description describes the electronic control device 30 being used in a vehicle that has an ABS system, it conceivable that the electronic control device 30 be used in a vehicle that is not equipped with an ABS system.

While the present invention has been illustrated by the description of example processes and system components, and while the various processes and components have been described in detail, applicant does not intend to restrict or in any way limit the scope of the appended claims to such detail. Additional modifications will also readily appear to those skilled in the art. The invention in its broadest aspects is therefore not limited to the specific details, implementations, or illustrative examples shown and described. Accordingly, departures may be made from such details without departing from the spirit or scope of applicant's general inventive concept.

What is claimed is:

1. An apparatus for a vehicle having at least one driven rear axle and at least one undriven rear axle, the apparatus comprising:
a data storage device arranged to store a slip threshold value at which a powertrain braking function of the vehicle is disabled;
a first sensor for detecting wheel speed of a wheel on the driven rear axle of the vehicle and providing a first signal indicative thereof;
a second sensor for detecting wheel speed of a wheel on the undriven rear axle of the vehicle and providing a second signal indicative thereof;
a third sensor for detecting a condition of the vehicle and providing a third signal indicative thereof; and
an electronic controller arranged to (i) process at least the first and second signals to provide a fourth signal indicative of an amount of longitudinal wheel slip between the driven rear axle and the undriven rear axle, and (ii) modify the stored slip threshold value based on a combination of the third and fourth signals.

2. An apparatus according to claim 1, wherein the third sensor comprises a sensor for detecting intent of a vehicle driver applying brakes of the vehicle.

3. An apparatus according to claim 2, wherein the electronic controller arranged to modify the stored slip threshold value based on a combination of the third and fourth signals includes the electronic controller arranged to modify the stored slip threshold value when the third signal indicates that a vehicle driver is not applying the vehicle brakes.

4. An apparatus according to claim 1, wherein the third sensor comprises a sensor for detecting brake pressure in a brake line of the vehicle.

5. An apparatus according to claim 4, wherein the electronic controller arranged to modify the stored slip threshold value based a combination of the third and fourth signals includes the electronic controller arranged to modify the stored slip threshold value when the third signal indicates that a brake pressure in a brake line of the vehicle is not above a predetermined brake pressure threshold.

6. An apparatus according to claim 2, wherein the electronic controller arranged to modify the stored slip threshold value based on a combination of the third and fourth signals includes the electronic controller arranged to modify the stored slip threshold value when the third signal indicates that a vehicle driver is applying the vehicle brakes and the fourth signal indicates that the amount of longitudinal wheel slip is less than a predetermined slip threshold.

7. An apparatus according to claim 1, wherein the electronic controller is further arranged to store the modified slip threshold value in the data storage device.

8. An apparatus according to claim 7, wherein the modified slip threshold value is greater than the stored slip threshold value that is unmodified.

9. An apparatus for a vehicle having at least one driven rear axle and at least one undriven rear axle, the apparatus comprising:
a data storage device arranged to store a slip threshold value at which a powertrain braking function of the vehicle is disabled;
a sensor for detecting intent of a vehicle driver applying brakes of the vehicle and providing a signal indicative thereof; and
an electronic controller arranged to modify the stored slip threshold value when the signal from the sensor indicates that the vehicle driver is not applying the vehicle brakes.

10. An apparatus according to claim 9, wherein the sensor comprises an electric potentiometer that is operatively coupled to a foot brake pedal of the vehicle.

11. An apparatus according to claim 9, wherein the sensor comprises a pressure sensor that is operatively coupled to a brake pressure line of the vehicle.

12. A method of operating a vehicle having at least one driven rear axle and at least one undriven rear axle, the method comprising:
storing a slip threshold value at which a powertrain braking function of the vehicle is disabled;
detecting wheel speed of a wheel on a driven rear axle of the vehicle and providing a first signal indicative thereof;
detecting wheel speed of a wheel on an undriven rear axle of the vehicle and providing a second signal indicative thereof;
detecting a condition of the vehicle and providing a third signal indicative thereof;
determining an amount of longitudinal wheel slip between the wheel on the driven rear axle and the wheel on the undriven rear axle based on a reference velocity and at least the first and second signals and providing a fourth signal indicative thereof; and
modifying the stored slip threshold value based on a combination of the third and fourth signals and providing a modified slip threshold value.

13. A method according to claim 12, wherein modifying the stored slip threshold value based on a combination of the third and fourth signals includes modifying the stored slip threshold value when the third signal indicates that a vehicle driver is not applying the vehicle brakes.

14. A method according to claim 12, wherein modifying the stored slip threshold value based on a combination of the third and fourth signals includes modifying the stored slip threshold value when the third signal indicates that a brake pressure in a brake line of the vehicle is not above a predetermined brake pressure threshold.

15. A method according to claim 12, wherein modifying the stored slip threshold value based on a combination of the third and fourth signals includes modifying the stored slip threshold value when the third signal indicates that a vehicle driver is applying the vehicle brakes and the fourth signal indicates that the amount of longitudinal wheel slip is less than a predetermined slip threshold value.

16. A method according to claim 12, wherein modifying the stored slip threshold value based on a combination of the third and fourth signals includes increasing the stored slip threshold value.

17. A method according to claim 12, wherein the method is performed by a computer having a memory executing one or more programs of instructions which are tangibly embodied in a program storage medium readable by the computer.
